(19) United States
(12) Patent Application Publication
(10) Pub. No.: US 2013/0282775 A1
(43) Pub. Date: Oct. 24, 2013

(54) DATA MANAGER CENTRALIZED STORAGE FOR MULTIPLE SERVICE APPLICATIONS

(71) Applicant: ABB TECHNOLOGY AG., Zurich (CH)

(72) Inventors: KEVIN DALE STARR, Lancaster, OH (US); TIMOTHY ANDREW MAST, Plain City, OH (US)

(73) Assignee: ABB TECHNOLOGY AG., Zurich (CH)

(21) Appl. No.: 13/749,778

(22) Filed: Jan. 25, 2013

Related U.S. Application Data
(60) Provisional application No. 61/636,941, filed on Apr. 23, 2012.

(51) Int. Cl. G06F 17/30

(52) U.S. Cl. CPC G06F 17/30138
USPC 707/825

(57) ABSTRACT

Basic data storage units are defined as tags that each have a particular data value and represent a single piece of data storage representing a logged data value within a centralized data storage system. Each of the tags have associated properties representing metadata stored for each tag comprising a size of the data for that tag or a source of the data for that tag. Each entry into the centralized data storage system represents the particular data value of each of the tag at an instant in time. All data entries in the centralized data storage system comprise one each of the tags, the particular data value of the each tag, and a timestamp for the each tag.

### CROSS-REFERENCE TO RELATED APPLICATION

This application is a continuation, and claims priority, of a U.S. provisional patent application by Starr et al for DATA MANAGER CENTRALIZED STORAGE FOR MULTIPLE SERVICE APPLICATIONS, filed in the U.S. Patent and Trademark Office on May 23, 2012 and assigned Ser. No. 61/636,941, confirmation number 8380.

### TECHNICAL FIELD OF THE INVENTION

Embodiments of the present invention relate to centralized data storage systems for pluralities of automation or service applications.

### BACKGROUND

General purpose data historians excel at the task of storing large amounts of continuous data. However, several issues with general purpose historians may prevent them from being used by service organizations. A first of these issues is the fact that data collection is often integrated into the historian, which may make it difficult to use the historian against a variety of systems.

A second issue covers the installation fingerprint of the general purpose historian. Because most historians are intended to collect large amounts of data, they often have a fairly large installation fingerprint. It is not unusual for a historian to require one (or possibly more) dedicated servers to collect data. A third issue is the cost of the historian software itself. Together with the cost of dedicated hardware, the price of the data storage software may approach or exceed revenues necessary to support delivery of the service. A fourth issue is that general purpose historians are generally to collect continuous data from all the input points in a system, and it may become difficult to determine which pieces of information are important and which are of interest to the service at hand.

### BRIEF SUMMARY

In one embodiment, a system has a processing unit, computer readable memory and a tangible computer-readable storage medium with program instructions, wherein the processing unit, when executing the stored program instructions, defines basic data storage units as tags that each have a particular data value and represent a single piece of data storage representing a logged data value within a centralized data storage system. Each of the tags have associated properties representing metadata stored for each tag comprising a size of the data for that tag or a source of the data for that tag. Each entry into the centralized data storage system represents the particular data value of each of the tag at an instant in time. All data entries in the centralized data storage system comprise one each of the tags, the particular data value of the each tag, and a timestamp for the each tag. If other non-defined metadata is stored in the centralized data storage system for each of the tags, the centralized data storage system does not attempt to interpret the other non-defined metadata but instead passes the other non-defined metadata on to a consuming application unchanged.

In another embodiment, an article of manufacture has a tangible computer-readable storage medium with computer readable program code embodied therewith, the computer readable program code comprising instructions that, when executed by a computer processing unit, cause the computer processing unit to define basic data storage units as tags that each have a particular data value and represent a single piece of data storage representing a logged data value within a centralized data storage system. Each of the tags have associated properties representing metadata stored for each tag comprising a size of the data for that tag or a source of the data for that tag. Each entry into the centralized data storage system represents the particular data value of each of the tag at an instant in time. All data entries in the centralized data storage system comprise one each of the tags, the particular data value of the each tag, and a timestamp for the each tag. If other non-defined metadata is stored in the centralized data storage system for each of the tags, the centralized data storage system does not attempt to interpret the other non-defined metadata but instead passes the other non-defined metadata on to a consuming application unchanged.

In another embodiment of the present invention, a method defines basic data storage units as tags that each have a particular data value and represent a single piece of data storage representing a logged data value within a centralized data storage system. Each of the tags have associated properties representing metadata stored for each tag comprising a size of the data for that tag or a source of the data for that tag. Each entry into the centralized data storage system represents the particular data value of each of the tag at an instant in time. All data entries in the centralized data storage system comprise one each of the tags, the particular data value of the each tag, and a timestamp for the each tag.

### BRIEF DESCRIPTION OF THE DRAWINGS

These and other features of this invention will be more readily understood from the following detailed description of the various aspects of the invention taken in conjunction with the accompanying drawings in which:

FIG. 1 is a block diagram illustration of an eco-system of applications with a Data Manager according to the present invention at the core.

FIG. 2 is a graphical representation illustration of discontinuous blocks of rich data stored in association with defined events by a Data Manager according to the present invention.

FIG. 3 is a graphical representation illustration of discontinuous blocks of rich data stored in association with defined events by a Data Manager according to the present invention.

FIG. 4 is a graphical representation illustration of discontinuous blocks of rich data stored in association with defined events by a Data Manager according to the present invention.

FIG. 5 is a graphical representation illustration of an association of KPIs with single events according to the present invention.

FIG. 6 is a graphical representation illustration of KPIs calculated based on the values from multiple events and shown in association with a group of events according to the present invention.

FIG. 7 is a block diagram illustrating an exemplary computerized implementation of a system and method according to the present invention.

FIG. 8 is a flow chart illustrating a method or process according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Embodiments of the present invention provide a centralized data storage system for a plurality of service applications, hereinafter sometimes referred to as the “Data Manager,” “DataPRO” or “DataPRO” system. Data Manager provides a common location for storage of process data which supports the various services provided by the service arm of a service provider. Data Manager need not supplant any process historians owned by a customer or provided to a customer by a service provider. Unlike process historians which store large amounts of data for unspecified future analysis, Data Manager may store smaller amounts of targeted data to allow the delivery of specific targeted services to the customer.

Data collection may be handled by tools and applications external to the Data Manager, which may provide an Application Programming Interface (API) which allows these external applications to store data. There may be multiple external data collectors purpose-built to collect data from the various field devices in use in equipment and systems, and Data Manager is designed to be a storage place for that data.

Data Manager provides a data storage application with a well-defined API that allows for entering and extracting data. Other external applications can be written to interface with Data Manager to provide data in other formats, or to interface the data extraction from Data Manager with other applications. Other functionality may be performed by external applications, which can be written to interface with the Data Manager API.

Embodiments of the Data Manager allows for storage of specific targeted information to support service delivery, and define a solid API that allows the storage and retrieval of said data. Data storage need not be continuous, but may be event based. Data may be grouped in such a way that it is easy to extract related information. Data Manager APIs are generally designed in such a way that the various types of structured data do not need to be defined at the time that Data Manager is designed. In one aspect this allows definition of structured data objects after underlying data has been committed to a database. Retrieval of data may be based on a given time period, or based on time based events defined in the system. Designed to be extensible so that the system does not need to be extended each time a new storage or retrieval system is implemented, this also allows for storage of both scalar and array values, and for storage of Key Performance Indicators (KPIs) along with data that may be attached to data and events. Although KPIs are stored with data, they do not need to be calculated and stored at the same time as the data.

Data Manager need not generally do any data collection or general purpose data extraction providing other than the API. Data Manager is not generally designed to replace a general purpose data historian, or to support continuous data collection. The API and data storage are generally not designed with a single particular application in mind. The API does not generally expose properties, methods, structures or events that are tied to a particular application, industry, or technology, but instead the API is generally designed to shield client applications from any changes in the underlying database system.

General purpose data historians generally excel at the task of storing large amounts of continuous data. However, several issues with most general purpose historians prevent them from being used by a service organization in the way the Data Manager may be implemented. For example, data collection is often integrated into the historian, and such integrated data collection may make it difficult to use the historian against a variety of systems. Some historians are tied to a particular interface, and others are tied to a particular platform or application. Because a service organization covers all types of equipment from modern to obsolete, the data collection platform chosen should not be tied to any specific technology. In addition, as the scope of service organization expands, new requirements are continually being added in terms of what types of systems are providing data. If the data collection portion is integrated into the data storage platform, it tends to fragment the installed base of the storage platform (e.g. many different versions installed around the world). This in turn causes maintenance challenges that can quickly consume the maintenance efforts of the development team.

Because most historians are intended to collect large amounts of data, they often have a fairly large installation fingerprint. It is not unusual for a historian to require one (or possibly more) dedicated servers to collect data. The costs of dedicated servers may exceed the cost of delivery of certain services, and provide a major stumbling block. Additionally, historian software is often priced with the assumption that it is part of larger project and priced accordingly. However, the issue of software cost becomes one of scale when viewed at the price level at which a service organization operates. A software cost as part of a larger project may be reasonable but untenable as part of a smaller service delivery.

General purpose historians generally collect continuous data from all input points in a system. From a system perspective, this is a perfectly reasonable solution as it allows for the capture of everything that takes place on a system. However, from a service perspective, this is less than ideal because it allows for the capture of too much information. If everything on a system is captured, it becomes difficult to determine which pieces of information are important and which are of interest to the service at hand. Designing a data storage system for discontinuous data places the burden of identifying ‘interesting’ pieces of data on the data collection applications instead, which may also ensure that all the data stored in the system is of interest to the service organization in the context of delivering a service. To use an analogy, with a general purpose historian, the task of finding sections of interesting data is like finding a needle in a haystack. In contrast, Data Manager creates a bucket of needles, every one of which is valuable and interesting.

Most integrated historians are designed with a particular platform or application in mind. From a service perspective, this is not desirable because service has to deal with a variety of platforms and applications. Any data storage solutions which are tied to a particular platform or application present problems. Going with this approach, either the service organization may have to turn down business because it doesn't have a data collection or data storage application for a customer's particular platform, or the service organization may need to learn and support a large variety of collection/storage applications. Either approach is not a good long term solution for the service business. In the first case, where the service organization can only support customers with a particular type of system, it artificially limits the size of the market that can be reached. Any technological decisions which arbitrarily limit the scope of the business decision should be rejected. In the second case, where the various data collection units are integrated with the data storage system, the system evolves rapidly with each additional type of data collection. This may result in every installation of the data storage system being different due to the rapidly changing pace of the software. The maintenance effort involved in this type of situation is large and can quickly overwhelm a small development team that has been structured to be small and nimble.

Data Manager embodiments according to the present invention are designed to store data, wherein other functions related to data (such as data collection and data extraction) may be done by external applications. In the case of data collection, this means that data collectors can be added as new platforms/services are added to a service portfolio without impacting a code base for Data Manager. The data collection and data extraction applications may change as service scopes expand, but the central core of Data Manager may remain the same. In this way, a service organization can create a rich eco-system of applications with Data Manager at the core. An example of this eco-system with examples can be seen in FIG. 1.

The argument for not including a general purpose data extraction tool in Data Manager is similar to an argument for not including a data collection layer in Data Manager. One of the design goals of Data Manager is to isolate the data storage layer from the collection and extraction layers as much as possible. This is harder to do with a data extraction layer because the capabilities of the data extraction layer will be limited to those features exposed by the Data Manager API. Because any data extraction utilities may be constrained by the API, an argument can be made that the data extraction is integral to Data Manager. While this is true to some extent, much of the usability of a data extraction layer is in what the extraction does with the data. In some cases, it might be to present the data in a visible manner to the end user. In other cases, it might be to store the extracted data in a file, send it to a data analyzer, or expose it to other applications through an OPC server. All of these uses are valid uses of the data stored in Data Manager. However, such functionality may more properly belong in other applications, not in Data Manager itself. By designing these applications independently of Data Manager, it allows those applications to be developed outside of the scope of a Data Manager project and with few dependencies on Data Manager other than the publicly exposed API. From an installation and maintenance standpoint, this is a desirable situation. The core Data Manager capabilities may be contained in one installation package. Any external capabilities can be added or modified as needed without touching the core. Enforcing this split at the beginning of the design process fosters the ability to later grow a rich eco-system as seen in FIG. 1.

As discussed above, other prior art products in a service provider portfolio may fail to address all the needs of a service organization when it comes to a data storage application. The data storage application for a service organization generally needs to be easy and lightweight to install; have a low delivery cost to the customer and the service organization; not be tied to any particular platform or application; not be tied to any particular industry; be able to store data on an non-continuous, event basis; and be able to store KPIs on a non-continuous, event basis. Based on these requirements, it is apparent that it is desirable for a service organization to employ Data Manager to provide a dedicated, service-based data storage application that can be used as the hub of a larger application infrastructure that could enable a next generation of service delivery.

The basic unit of Data Manager is a particular data value, henceforth referred to as a tag. Each tag represents a single piece of data storage and represents a logged data value (OPC tag, IO point, report field, etc.) within the system. Each has properties associated with it to represent metadata about that tag. Some of the metadata stored for each tag are the data type of that tag, the size of the data for that tag and the source of the data for that tag. Other non-defined metadata may be stored in Data Manager for each tag. Data Manager generally does not attempt to interpret this metadata, but will simply pass it on to consuming applications unchanged.

Each entry into the data storage system represents the value of a tag at an instant in time. All data entries into the system consist of a tag, the value of that tag, and a timestamp for that tag.

Data Types.

In order to accommodate the variety of information to be stored in the system, Data Manager allows for tags to be strongly typed. The type information is generally stored with the metadata associated with each tag. Data types supported include floating point, integer, Boolean, date and string.

Data Sizes.

Data Manager tags can represent either scalar or array values. Array values are supported because in many industries arrays are used to represent measurement properties across a spatial dimension. For example, paper and flat-sheet industries represent sheet properties across the width of the web as arrays of real numbers. These arrays may be treated as a unit, and if so need to be represented as such.

In addition, array values can be one of two kinds, fixed length and variable length. Fixed length arrays are the most common, but variable length arrays need to be supported to accommodate those few measurement systems that report information as arrays with non-uniform lengths. Data sizes supported in Data Manager include scalar, fixed length array and variable length array.

Event Based Data Storage.

As discussed above, one of the defining features of Data Manager is the ability to store data which is not continuous in nature. Because the data is not continuous, Data Manager provides the ability to mark data for various time periods. These marks may be referred to as “events”, in one aspect because they represent data associated with some temporal occurrence on the system from which data is being collected.

Events.

Each event in the Data Manager system may represent something which has happened on the system in question which required further study. Events may be defined by the time at which the event started and the time at which the event completed. They may also have a type or types associated with them. These event types may be used by the extraction API to help filter data being pulled out of the Data Manager system. Each event can have multiple optional types associated with it.

Event types are generally defined by the applications storing the data. Data Manager itself may provide the ability to define these types and store these types, but need not have predefined types built into the system. This allows future flexibility as more services are added and additional event types are required.

Event types may be used to define metadata about an event. One example of an event type might be a “sheet break” event type on a paper machine. When a sheet break occurs on the system, the data collection application being used may create an event and assign a sheet break type to the event. Later extraction utilities may be able to extract all data for sheet break events without getting extra data that is associated with other types of events. Events may be defined by a variety of properties, for example start time, stop time and event type (optional).

Event Groups.

In addition to events, Data Manager generally needs to support the concept of groups of events. These event groups may be used primarily to identify KPI data. For example, in a paper system there is a class of events known as “reel reports” that are created at the end of every reel of paper. When later analysis is done, KPIs generated generally represent some information regarding a group of these reel report events. For example, the KPIs might represent some statistical information for all reel reports in the month of November. In order to properly associate these KPIs with the events and the associated data, the KPIs must generally be attached to a group of events. Event groups are defined by properties such as a list of events in the group.

Data Storage for Events.

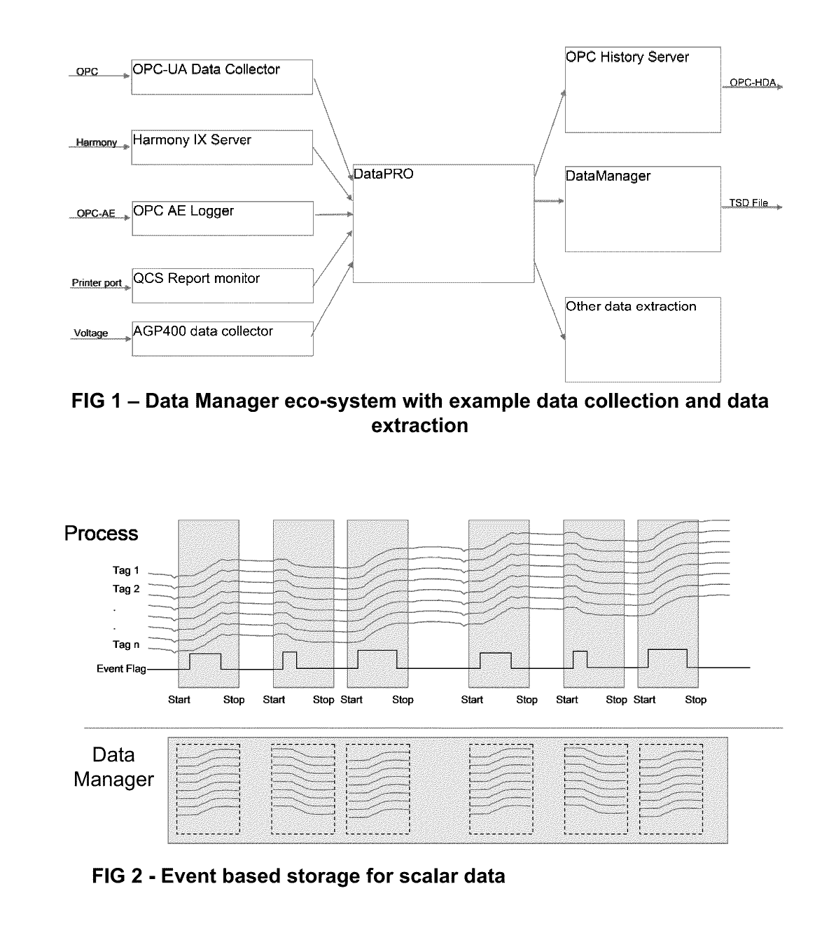

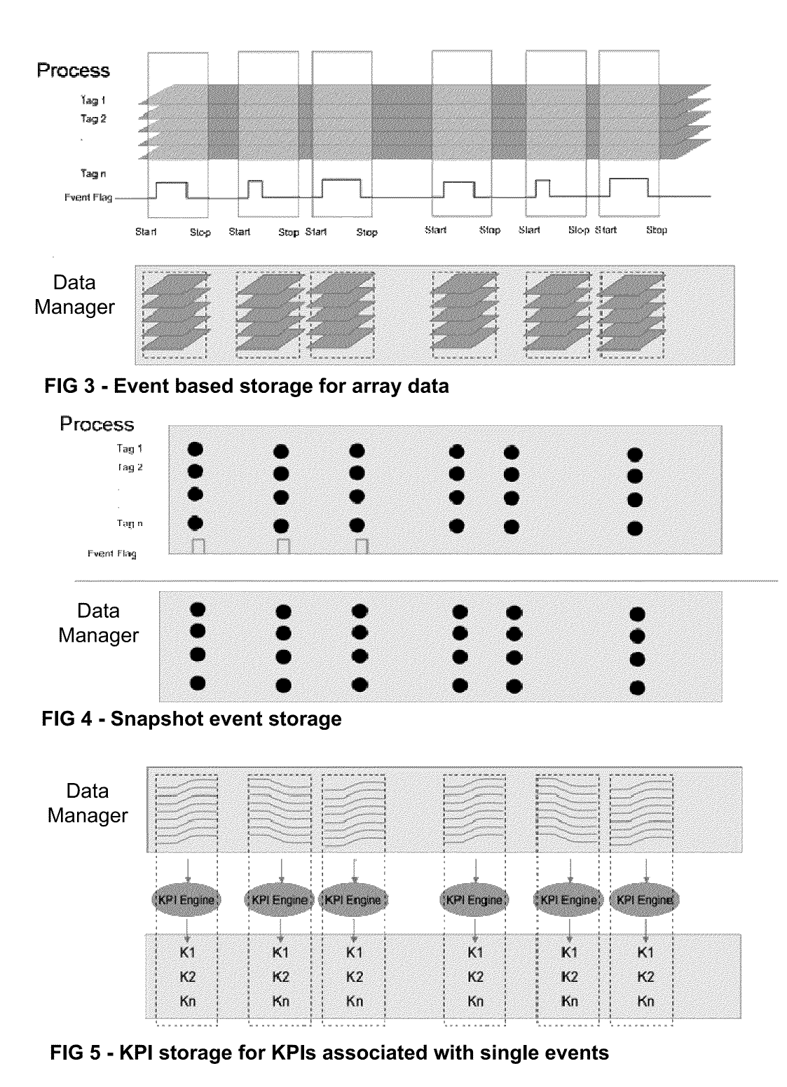

Data Manager stores data associated with events defined in the system. By the nature of event based storage, this data is generally not continuous data. There are distinct types of events for which data is stored. A first may be referred to as a “standard event,” and is characterized by a well-defined start and stop. During the time period between the start and stop of the event, data is collected by the external data collection system and placed into storage in Data Manager. The resulting data is generally discontinuous blocks of rich data. An example of this type of event data storage can be seen in FIGS. 2 and 3. These figures illustrate graphically how data is broken due to an event-based nature of the data storage. The figures are only for exemplary illustration, and alternatively the data set could contain a mixture of scalar and array data as well as a variety of other numeric and non-numeric data.

Another type of event based storage is a “degenerate form” of the standard event, wherein the start and stop times for the event are essentially identical. In effect, this event will only capture a snapshot of the values for the data associated with the event and may be known as a snapshot event. An example of a snapshot event and how the data would be captured in Data Manager can be seen in FIG. 4.

KPI Storage.

In addition to process data, Data Manager provides a method of storing Key Performance Indicators (KPI) associated with the data. The rationale behind storing KPIs along with the data is two-fold. First, the argument can be made that data by itself is worthless, but that the value of data is in the conclusions that can be drawn from the data. KPIs are a way of distilling the raw data down to numerical values that more clearly show the conditions in the process. Because such KPIs are at least as valuable as the data itself, it makes sense that they would be stored. The second reason for storing the KPIs in the repository for the data itself is that no KPI calculation is completely foolproof. By keeping the KPIs and the raw data together, it is possible at any point in the future to recalculate the KPIs and verify their integrity with the same data from which they were initially calculated.

KPIs Attached to Events.

Because the data in Data Manager is stored by event, it makes sense that KPIs be stored based on the same events. This method ensures that it is always possible to view the raw data from which a KPI derives. KPIs in Data Manager can be attached to either events or groups of events. When a KPI is attached to an event, it indicates that the data associated with the event is the data from which the KPI was calculated. Data Manager may be completely agnostic with respect to KPIs, providing a place for storing the KPI values and associating them with the data, yet without understanding the values of the KPI or how they relate to the actual data. Thus, embodiments may combine KPI's with raw data into an event-driven snapshot, and this type of association may be the responsibility of the various applications which make use of Data Manager for data storage.

KPIs in Data Manager need not be calculated at the same time as the data is stored. In fact, in many cases, this is not possible. One example is a KPI which looks at aggregated values over some time period. For example, a KPI might be the average time for grade changes during the month of May. In this case, the KPI could only be calculated at the end of the month, long after the data itself was put into the system. The KPI may be attached to an event group containing all the grade change events for the month of May. This allows for the ability to examine the raw data which made up the KPI, in the event that the KPI is reexamined.

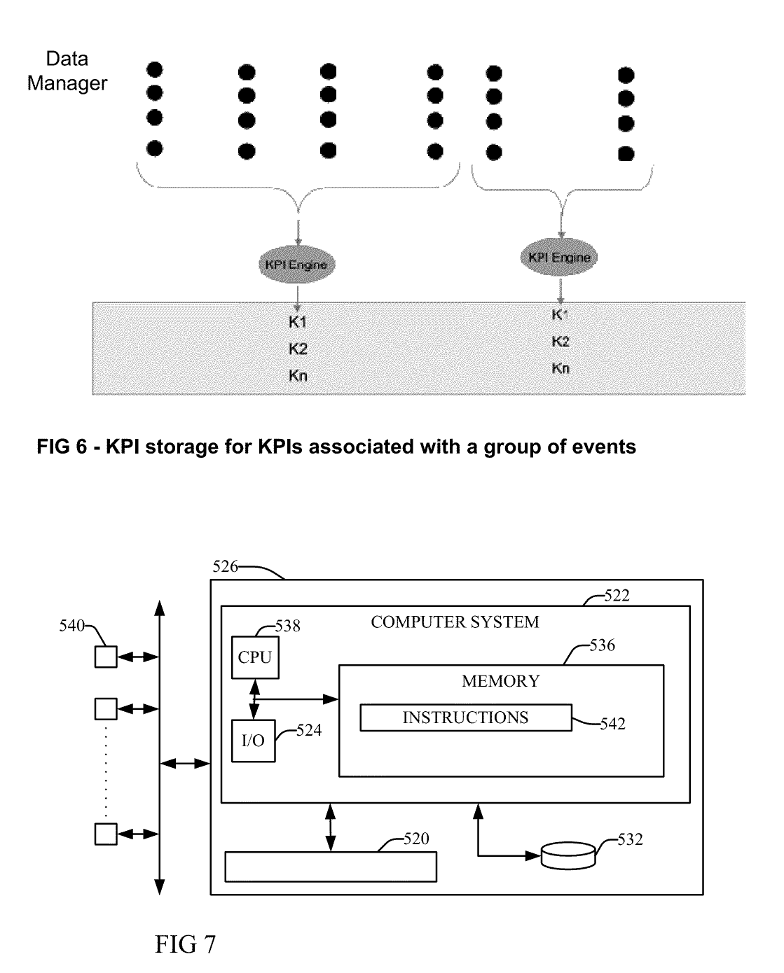

Some graphical examples of how the KPIs are associated with the data are seen in FIG. 5 and FIG. 6. FIG. 5 is an example of how KPIs are associated with single events. In this case, a KPI engine (external to Data Manager) calculates KPIs based on the data from a single event, and then inserts the values back into Data Manager and associates them with that event. In FIG. 6, the KPIs illustrated are calculated based on the values from multiple events and are shown in association with a group of events.

Tag Groups.

Because of the way that data is stored in Data Manager, it is logical to associate tags with particular events. However, it is also beneficial to associate tags with each other in logical groups. For example, data recorded from a control system might be grouped according to the controller. A process tag group for a PID control may contain the tags for the setpoint, measured value and controller output. A second tag group may contain the tuning tags for that controller.

Grouping tags together in logical groups allows for easier data extraction. If data is grouped according to logical groups and according to events, it is possible to make richer queries from the extraction API. For example, one could ask for the process data for controllers during grade change events during the month of June. This type of rich data extraction allows for the selection of only rich data sets for external analyzers.

Tag groups are logical groupings of individual tags. They represent groups of data which are logically associated with each other. Because data is stored at the tag level rather than the group level, individual tags can be associated with multiple tag groups with no duplicated storage. For example, the setpoint on a weight control might be associated with a tag group type for all PID controllers, as well as be associated with a tag group type for all level 2 supervisory controls.

Another side effect of the fact that data is stored at the tag level rather than the group level is that tag group definitions can be set up after the fact. It is possible that some grouping of tags might not be discovered until after the data was logged. Because the association of tags with tag groups is a high level abstraction, the grouping can be done or modified long after the data itself is stored.

Data Manager itself will need not have an understanding of a particular tag grouping. The tag groupings are defined through the API layer. Data Manager will maintain the data structures to define and store these tag groupings, but the meaning of each type of tag grouping will be determined by the external clients of Data Manager. Each external analyzer system will have the ability to define and store their unique tag groupings in the generic data structures of Data Manager.

Interfaces.

Data Manager may run as a service on a target computer. It is generally not a user-mode application. Data Manager itself may not have a user interface. As part of a Data Manager project some external applications may be created, such as a Data Manager administration application. However, the core functionality of Data Manager generally does not generally require any user interface.

Interface to Other Applications.

Generally the methodology for communicating with a Data Manager application is through the API layer provided by Data Manager. This layer is generally a well-documented interface accessed through a web service. Using a web service to access Data Manager gives the various external applications which need to interface with Data Manager more flexibility with regards to how they communicate with Data Manager. The API layers may shield the external clients from the implementation details of the actual storage layer. This allows the external applications to be written even as the underlying details of the data storage are refined.

External APIs.

Illustrative but not exhaustive examples of primary APIs for Data Manager include a data input API layer used to store data in Data Manager; it is used primarily by the various external data collectors that gather data from the process equipment. A Data extraction API layer is used to pull data out of Data Manager; it is used primarily by the various external analyzers and data extraction utilities to gather process data from Data Manager. A Metadata manipulation API layer is used to define event types, tag groups and other metadata definitions in Data Manager; it is generally separated from the input and extraction APIs in order to reduce the complexity of each API as well as to allow for future security considerations if needed. A Data Manager administrative API is used only by internal administrative tools written against Data Manager; these tools enable operations such as starting and stopping the Data Manager service, querying the status of Data Manager, and flushing data from the storage medium.

Security.

Some embodiments of Data Manager do not contain any overt security. However, said embodiments may be designed with the assumption that security will eventually be added into the system, and generally handled on a user level. Such security levels are generally defined to restrict what operations the end user can perform against the data storage system.

Supporting Applications.

Data Manager creates a rich data source which may be the center of an eco-system of applications that operate together to allow for the delivery of service products in a cost efficient and profitable manner. Several different classes of applications may be part of this eco-system. For example, data capture applications may pull process data out of actual equipment and store it in Data Manager. Data extraction applications may pull data out of the Data Manager system to be used by various analyzer applications. Management applications may provide a primary way of administering Data Manager; because of the modular and disconnected way in which the application eco-system may be designed, it is possible that a variety of management applications may be practiced with the present embodiment, including a light-weight, reduced functionality management application.

Referring now to FIG. 7, an exemplary computerized implementation of an embodiment of the present invention includes a computer system or other programmable device 522 in communication with data sources 540. Instructions 542 reside within computer readable code in a computer readable memory 536, or in a computer readable storage system 532, or other tangible computer readable storage medium that is accessed through a computer network infrastructure 526 by a processing unit (CPU) 538 or an input-output (I/O) 524. Thus, the instructions, when implemented by the processing unit (CPU) 538, cause the processing unit (CPU) 538 to provide the Data Manager system described above.

Embodiments of the present invention may also perform process steps of the invention on a subscription, advertising, and/or fee basis. That is, a service provider could offer to integrate computer-readable program code into the computer system 522 to enable the computer system 522 to provide the Data Manager system described above. The service provider can create, maintain, and support, etc., a computer infrastructure such as the computer system 522, network environment 526, or parts thereof, that perform the process steps of the invention for one or more customers. In return, the service provider can receive payment from the customer(s) under a subscription and/or fee agreement. Services may comprise one or more of: (1) installing program code on a computing device, such as the computer device 522, from a tangible computer-readable medium device 520 or 532; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the Figures, may be distinguished or otherwise identified from others by unique adjectives (e.g., a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

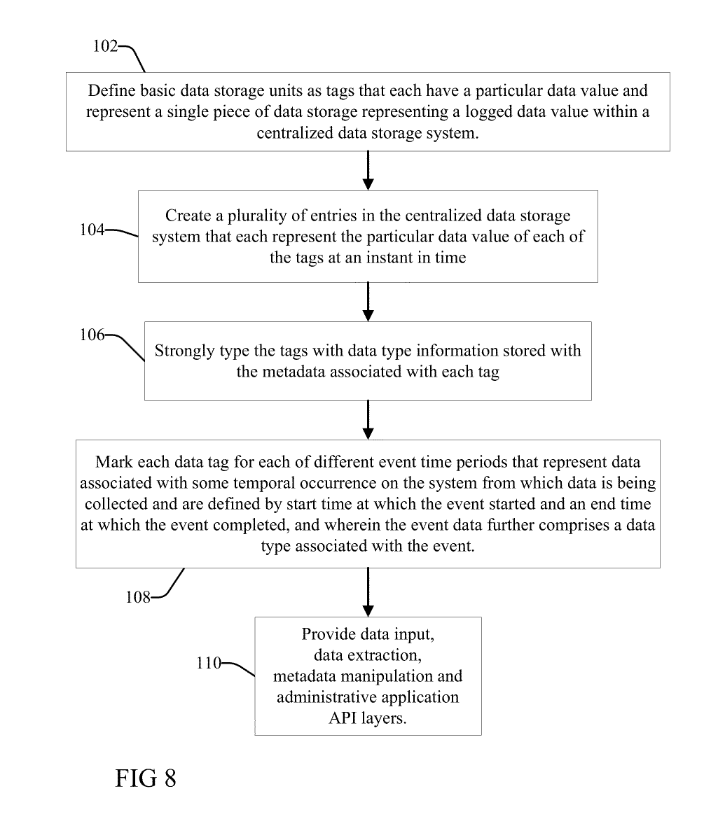

In view of the above, FIG. 8 illustrates a method or process according to the present invention for providing centralized data storage for a plurality of service applications. At 102 a plurality of basic data storage units are defined as tags that each have a particular data value and represent a single piece of data storage representing a logged data value within a centralized data storage system. Each of the tags have associated properties representing metadata stored for each tag comprising a size of the data for that tag or a source of the data for that tag.

At 104 a plurality of entries are created in the centralized data storage system that each represent the particular data value of each of the tags at an instant in time. All data entries in the centralized data storage system comprise one each of the tags, the particular data value of the each tag, and a timestamp for the each tag.

At 106 the tags are strongly typed with data type information stored with the metadata associated with each tag. The data types supported by the centralized data storage system comprise floating point, integer, Boolean, date and string data types; the tags represent scalar or array values; and the array values are fixed length or variable length.

At 108 each data tag is marked for each of a plurality of different event time periods that represent data associated with some temporal occurrence on the system from which data is being collected and are defined by a time at which the event started and a time at which the event completed, and wherein the event data further comprises a data type associated with the event.

At 110 a plurality of application programming interfaces (API's) are provided, including a data input application programming interface layer that is used by an external data collector to store data gathered data from a process equipment device; a data extraction application programming interface layer that is used by an external analyzer or data extraction utility to pull process data out of the centralized data storage system; a metadata manipulation application programming interface layer that is separate from the data input application programming interface layer and the data extraction application programming interface layer and is used to define event types, tag groups and metadata definitions in the centralized data storage system; and an administrative application programming interface layer that is used only by internal administrative tools that enable starting, stopping, status querying or flushing data operations with respect to the centralized data storage system.

What is claimed is:

1. A centralized data storage system for a plurality of service applications, the system, comprising:
a processing unit in communication with a computer readable memory and a tangible computer-readable storage device;
wherein the processing unit, when executing program instructions stored on the tangible computer-readable storage device via the computer readable memory:
defines a plurality of basic data storage units as tags that each have a particular data value and represent a single piece of data storage representing a logged data value within the centralized data storage system;
wherein each of the tags have associated properties representing metadata stored for each tag comprising a size of the data for that tag or a source of the data for that tag;
wherein each entry into the centralized data storage system represents the particular data value of each of the tag at an instant in time;
wherein all data entries in the centralized data storage system comprise one each of the tags, the particular data value of the each tag, and a timestamp for the each tag; and
wherein if other non-defined metadata is stored in the centralized data storage system for each of the tags, the centralized data storage system does not attempt to interpret the other non-defined metadata but instead passes the other non-defined metadata on to a consuming application unchanged.

2. The system of claim 1, wherein the tags are strongly typed with data type information stored with the metadata associated with each tag, and wherein the data types supported by the centralized data storage system comprise floating point, integer, Boolean, date and string data types.

3. The system of claim 2, wherein the tags represent scalar or array values, and the array values are fixed length or variable length.

4. The system of claim 3, wherein the processing unit, when executing program instructions stored on the tangible computer-readable storage device via the computer readable memory, further marks each data tag for each of a plurality of different event time periods that represent data associated with some temporal occurrence on the system from which data is being collected and are defined by a time at which the event started and a time at which the event completed, and wherein the event data further comprises a data type associated with the event.

5. The system of claim 4, wherein the processing unit, when executing program instructions stored on the tangible computer-readable storage device via the computer readable memory, further defines the event data as one of:
a standard event comprising different start and stop times; or
a degenerate event comprising identical times for the start and stop times for the event.

6. The system of claim 5, wherein the processing unit, when executing program instructions stored on the tangible computer-readable storage device via the computer readable memory, further stores key performance indicators based on the events in association with the tag data.

7. The system of claim 6, wherein the processing unit, when executing program instructions stored on the tangible computer-readable storage device via the computer readable memory, further groups the tags together in logical groups according to the events for data extraction.

8. The system of claim 7, wherein the processing unit, when executing program instructions stored on the tangible computer-readable storage device via the computer readable memory, defines and saves or modifies the tag group level definitions after storing the tags.

9. The system of claim 8, wherein the processing unit, when executing program instructions stored on the tangible computer-readable storage device via the computer readable memory, further provides API layers for the centralized data storage system comprising:
a data input API layer used to store data in the centralized data storage system that is used by an external data collector to gather data from a process equipment device;
a data extraction API layer that is used by an external analyzer or a data extraction utility to pull process data out of the centralized data storage system;
a metadata manipulation API layer that is separate from the data input API layer and the data extraction API layer and is used to define event types, tag groups and metadata definitions in the centralized data storage system; and
an administrative API layer that is used only by internal administrative tools that enable starting, stopping, status querying and flushing data operations with respect to the centralized data storage system.

10. An article of manufacture, comprising:
a computer readable tangible storage device having computer readable program code embodied therewith, the computer readable program code comprising instructions that, when executed by a computer processing unit, cause the computer processing unit to:
define a plurality of basic data storage units as tags that each have a particular data value and represent a single piece of data storage representing a logged data value within a centralized data storage system;
wherein each of the tags have associated properties representing metadata stored for each tag comprising a size of the data for that tag or a source of the data for that tag;
wherein each entry into the centralized data storage system represents the particular data value of each of the tag at an instant in time; and
wherein all data entries in the centralized data storage system comprise one each of the tags, the particular data value of the each tag, and a timestamp for the each tag.
wherein if other non-defined metadata is stored in the centralized data storage system for each of the tags, the centralized data storage system does not attempt to interpret the other non-defined metadata but instead passes the other non-defined metadata on to a consuming application unchanged.

11. The article of manufacture of claim 10, wherein the tags are strongly typed with data type information stored with the metadata associated with each tag:
the data types supported by the centralized data storage system comprise floating point, integer, Boolean, date and string data types;
the tags represent scalar or array values; and
the array values are fixed length or variable length.

12. The article of manufacture of claim 11, wherein the processing unit, when executing the program instructions stored on the tangible computer-readable storage device via the computer readable memory, further marks each data tag for each of a plurality of different event time periods that represent data associated with some temporal occurrence on the system from which data is being collected and are defined by a time at which the event started and a time at which the event completed, and wherein the event data further comprises a data type associated with the event.

13. The article of manufacture of claim 12, wherein the processing unit, when executing the program instructions stored on the tangible computer-readable storage device via the computer readable memory, further defines the event data as one of:
a standard event comprising different start and stop times; or
a degenerate event comprising identical times for the start and stop times for the event.

14. The article of manufacture of claim 13, wherein the processing unit, when executing the program instructions stored on the tangible computer-readable storage device via the computer readable memory, further stores key performance indicators based on the events in association with the tag data.

15. The article of manufacture of claim 14, wherein the processing unit, when executing the program instructions stored on the tangible computer-readable storage device via the computer readable memory, further groups the tags together in logical groups according to the events for data extraction.

16. A method for providing centralized data storage for a plurality of service applications, the system, the method comprising:
defining a plurality of basic data storage units as tags that each have a particular data value and represent a single piece of data storage representing a logged data value within a centralized data storage system, wherein each of the tags have associated properties representing metadata stored for each tag comprising a size of the data for that tag or a source of the data for that tag;
creating a plurality of entries into the centralized data storage system that each represent the particular data value of each of the tags at an instant in time, wherein all data entries in the centralized data storage system comprise one each of the tags, the particular data value of the each tag, and a timestamp for the each tag; and
wherein the tags are strongly typed with data type information stored with the metadata associated with each tag; the data types supported by the centralized data storage system comprise floating point, integer, Boolean, date and string data types; the tags represent scalar or array values; and the array values are fixed length or variable length.

17. The method of claim 16, further comprising marking each data tag for each of a plurality of different event time periods that represent data associated with some temporal occurrence on the system from which data is being collected and are defined by a time at which the event started and a time at which the event completed, and wherein the event data further comprises a data type associated with the event.

18. The method of claim 17, further comprising defining the event data as one of:
a standard event comprising different start and stop times; or
a degenerate event comprising identical times for the start and stop times for the event.

19. The method of claim 18, further comprising storing key performance indicators based on the events in association with the tag data.

20. The method of claim 19, further comprising:
providing a data input application programming interface layer that is used by an external data collector to store data gathered data from a process equipment device;
providing a data extraction application programming interface layer that is used by an external analyzer or data extraction utility to pull process data out of the centralized data storage system;
providing a metadata manipulation application programming interface layer that is separate from the data input application programming interface layer and the data extraction application programming interface layer and is used to define event types, tag groups and metadata definitions in the centralized data storage system; and
providing an administrative application programming interface layer that is used only by internal administrative tools that enable starting, stopping, status querying or flushing data operations with respect to the centralized data storage system.
